(19) United States
(12) Patent Application Publication
(10) Pub. No.: US 2026/0153665 A1
(43) Pub. Date: Jun. 4, 2026

(54) LIGHT-GUIDE REFLECTOR

(71) Applicant: BROALUX International Limited, Road Town (VG)

(72) Inventors: Yang-Jun ZHENG, Taipei City (TW); Chunte Richard WU, San Jose, CA (US)

(21) Appl. No.: 18/966,246

(22) Filed: Dec. 3, 2024

(51) Int. Cl. F21V 8/00

(52) U.S. Cl. CPC G02B 6/0055; G02B 6/0018; G02B 6/0046; G02B 6/006

(57) ABSTRACT

A light-guide reflector proposed here, which a light guide is shaped to be a reflector, i.e. a light-guide reflector. The light-guide reflector is wedge-like in the lateral sight view. A light-entering part (a groove with curve surfaces) at the thin end, a light-exiting part is at the thick end, and the lateral side connected the light-entering part and the light-exiting part is the reflection part. The light-guide reflector has a better illumination performance and effect.

### BACKGROUND OF THE INVENTION

### 1. Field of the Invention

The present invention relates to a reflector and especially to a reflector made by a light guide, called a light-guide reflector herein.

### 2. Description of the Prior Art

A conventional reflector used in lamp includes a chamber and a parabolic mirror. In general, a light source is put at the focus, the reflector around the source with a distance and a lamp transparent/semi-transparent cover on the reflector. The light chamber is defined as the space surrounded by the parabolic mirror and the lamp cover. The light from source flies to the parabolic mirror, is converted into a collimated beam and passes the lamp cover for illumination.

The illumination performance is determined by the light trapping capability of the reflector and the illumination profile effect is determined by the light beam of the reflector and the pattern of the lamp cover.

The reflection mirror defines the light-trapping capability for one conventional reflector. The loss can be caused by polishing degree and material of the mirror, the joints of the light-entering lens and the lamp cover with the reflection mirror. Further, the material of the reflection mirror also causes the light loss.

A light-guide reflector is proposed in this paper. The new reflector can increase the performance of an illumination profile or effect, increase illumination efficiency, reduce the weight, and increase miniaturization flexibility. The light-guide reflector can be used in many kinds of lamp, such as a car light, a motorcycle light and a bicycle light.

### SUMMARY OF THE INVENTION

The present invention proposes a light-guide reflector to enhance the illumination performance and/or the illumination profile.

The present invention proposes a light-guide reflector is one-piece component to have advantage of simplifying reflector manufacturing and shaping.

The light-guide reflector comprises a light guide with a light-entering part, a reflection part, and an exiting part of the light guide.

The light-entering part is a groove at the bottom (thin end) of the light guide and the internal surfaces of the groove comprises multiple curved surfaces. A light source is put below the light-entering part in general. Any curvature of these surfaces is able to guide a light to a specific area of the reflection part.

The reflection part is the lateral surface (connected with the thick end and the thin end) of the light guide. The lateral surface is inclined angle (zone angle) relative to a collimated axis, i.e. the reflection part is an inclined lateral surface. The inclined lateral surface comprises multiple planes, multiple tapered surfaces or their combination. The inclined angle of the reflection surface is designed to reflect the light from light-entering part and guided to a specific area of the light-exiting part.

The light-exiting part, at the top (thick end) of the light guider, can be a plane, convex or concave surface, or a surface with a pattern. The light passes the light-exiting part to generate an illumination profile or effect.

### BRIEF DESCRIPTION OF THE DRAWINGS

FIG. 1 shows a up-left top view of a light-entering part of a light-guide reflector according to an embodiment of the present invention.

FIG. 2 shows a up-right top perspective view of a light-entering part of the light-guide reflector according to an embodiment shown as FIG. 1.

FIG. 3 shows a left/right perspective view of the reflection part of the light-guide reflector according to an embodiment shown as FIG. 1.

FIG. 4 shows a front/rear perspective view of the reflection part of the light-guide reflector according to an embodiment shown as FIG. 1.

FIG. 5 shows the light path of the embodiment shown as FIG. 3.

FIG. 6 shows the light path of the embodiment shown as FIG. 4.

FIG. 7 shows the one-dimensional wave pattern of the light-exiting part of the embodiment shown as FIG. 2 and the light path in the light-guide reflector and the illumination effect.

FIG. 8 is a right view of an embodiment of the present invention to show a pattern of the light-guide reflector with an inhomogeneous thickness distribution, where the thickness decreases from left side to right side in this embodiment.

FIG. 9 is a front view of the embodiment in FIG. 8 to show the light path of the light-guide reflector to present the illumination effect.

### DESCRIPTION OF THE PREFERRED EMBODIMENT

The following embodiments and the diagrams are intended to illustrate the spirit of the present invention to person having ordinary skilled in the art to be clearly understand the technology of the present invention, but are not intended to limit its scope, which is defined by the claims. It is emphasized that the diagrams are for illustration only, and do not represent the actual size or quantity of components, and some details may not be fully drawn for the sake of simplicity of the diagrams.

The conventional reflector is, in general, a parabolic chamber with mirror surface to convert the light into a collimated light beam. The material of the mirror, the joints of the light mirror and its cover, and the hole for light source house perhaps cause the optical loss. The document proposes to use a light guide instead of the conventional reflector, and the new TIR (Total Internal Reflection) reflector can be applied to a lamp of a car, motorcycle, bicycle or the other illumination equipment. The new reflector enhances performance and illumination profile of the lamp.

### Introduction of the Present Invention

The light-guide reflector is a light guide with a specialized shape to catch and guide light to enhance an illumination effect and to present an illumination profile. The light-guide reflector comprises the light-entering part, the reflection part, and light-exiting part. From a lateral view-sight, the light-guide reflector is wedge-like and along a collimated axis, so the light guide has a thin end, a thick end and an inclined lateral side to connect the thin end and the thick end. The light-entering part is at the bottom (i.e. the thin end), the light-exiting part at the top (i.e. the thick end) and the reflection part is the lateral side (i.e the trapezoidal hypotenuse), which is inclined relative to the collimated axis. The refractive index and the inclined angle of the lateral side of the guide determines the light-trapped ability and illumination performance.

The light-entering part is a groove at the bottom of the reflector (the thin end) and the internal of groove include multiple curve surfaces to catch light from a light source, which is set at below the groove in general. The light source can be an LED or an LED array etc. The lateral side of the reflection part faces the lateral curve surfaces of the groove (i.e. the light-entering part) to accept the light from the light source. These curve surfaces of the groove are combined by a top surface and multiple lateral curve surfaces. The top surface of the groove generally is a convex surface to guide the light forward and any lateral curve surface can be a hyperbolic surface or a synclastic surface to guide the light to irradiate onto the reflection surfaces of the reflection part. The curvature of each lateral curve surface determines the angle of the entering light.

The reflection part, the inclined side of the light guide, is shaped to be inclined planes and tapered surfaces to guide the light to the light-exiting part. The inclined angle of the reflection part or the refractive index of the light guide determines the reflective rate. A good light guide can trap the light completely, so the reflector can enhance the light beam performance. The inclined plane(s) and the tapered surface(s) reflect the light to generate a specialized light beam when reaching the light-exiting part, for example, a collimated light beam (i.e. a beam has a homogeneous intensity on the cross section), an inclined light beam (i.e. a beam has a homogeneous intensity on the cross section with an inclined angle to the collimated axis) or a multi-directional light beam (it mean that there are many beams and each beam has its own direction).

In general, any inclined angle of tapered surfaces or inclined planes are the same as the inclined angle of the reflection part, however inclined angles of these tapered surfaces and incline planes can be also different. According to the desired illumination effect, the inclined angles of these tapered surfaces and the inclined planes are designed based on the curvatures of these lateral curve surfaces of the light-entering part. The reflected light beam can an inclined light beam, or a multi-directional light beam.

The light-exiting part is at top of the light-guide the can have a variant shape, called a pattern here, like a convex, concave, one-dimensional wave, two-dimensional wave, fish scales etc. The light beams from the reflection part pass the shape or the pattern and present a specialized illumination profile.

### Embodiments

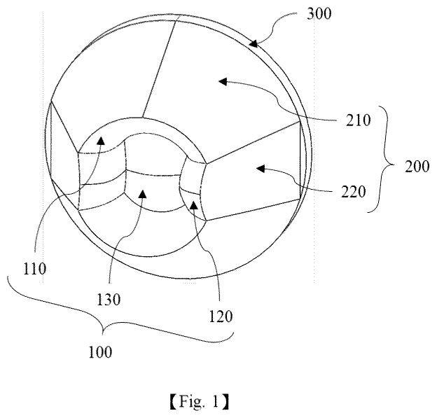

Embodiments below accompanied by drawings are used to explain the invention for better understanding. For a simplifying explanation of the present invention, the light-entering part is arranged in cylindrical symmetry along a collimated axis in this embodiment shown as FIG. 1. However, it is not necessary to be arranged in cylindrical symmetry in another embodiment. Besides, for simplifying the explanation, the direction of the tapered surface pair is defined as the front-rear direction, and that of the incline plane pair as the right-left direction hereinafter. However, it is noted that these directions are relative not the real orientation.

FIG. 1 shows the light-entering part 100 of a light-guide reflector according to an embodiment of the present invention. The light-entering part 100 comprises a pair of opposite hyperbolic surfaces 110, a pair of opposite synclastic surfaces 120, and one top convex surface 130.

The reflection part 200 can have many reflection surfaces but a simple structure is employed in this embodiment. In this case, the reflection part 200 comprises a pair of opposite tapered surfaces 210 and a pair of opposite inclined planes 220. The tapered surface 210 and the inclined plane 220 are respectively faced to the hyperbolic surface 110 and the synclastic surface 120. The top surface 130 is a convex to catch the light from the source and to guide the catch light forward, and the lateral curve surfaces 110, 120 guide the light to the reflection part.

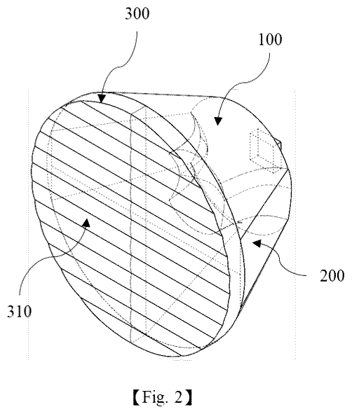

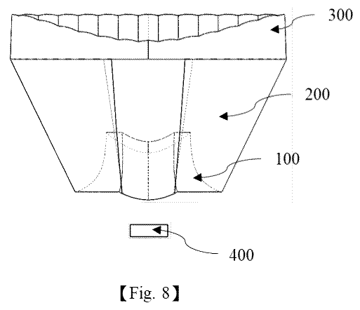

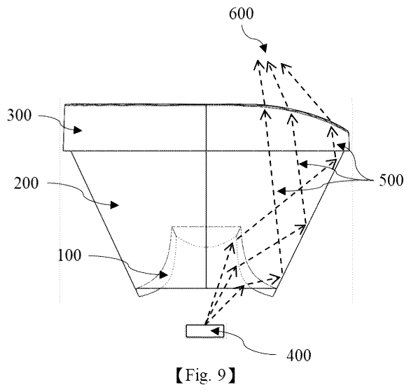

FIG. 2 shows the light-exiting part 300 with a pattern 310, which is a one-dimensional wave according to one embodiment of the present invention. The light reflected from the reflection part 200 passes he light-exiting part 300 to present the illumination effect. The pattern 310 can be a one-dimensional wave, a two-dimensional wave, a concentric-circle wave or a fish scale, and so on. In one embodiment, the pattern 310 is a non-uniform thickness layer. An example will be shown hereafter combined with FIG. 8 and FIG. 9.

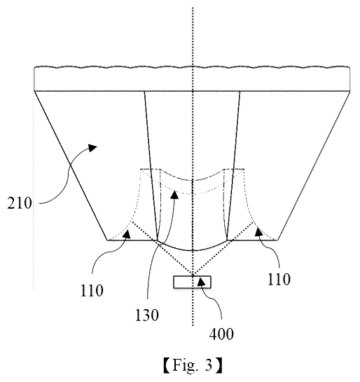

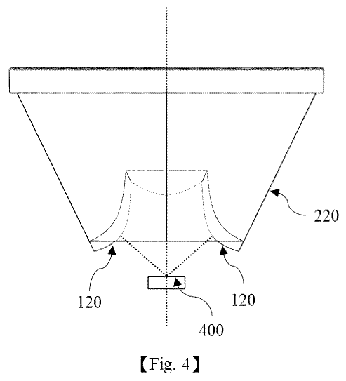

FIG. 3 and FIG. 4 respectively show the left/right respective view and rear/front of an embodiment shown as FIG. 1. The light-entering part 100, the reflection part 200, and the light-exiting part 300 are arranged in a cylindrical symmetry relative to the collimated axis, shown as the vertical line at the center in FIG. 3 and FIG. 4. However, it is noted again that the symmetry is not necessary. The light source 400 is disposed at below and outside the light-entering part 100. The tapered surfaces 210 are drawn at the left and right in FIG. 3 and the front face in FIG. 4. The inclined plane 220 is drawn at the front face of FIG. 3 and at the right end and left end in FIG. 4. The light-exiting part 300 is drawn at the top end and the light-entering part 100 at the bottom end. The structure drawn by dot lines is the light-entering part 100 inside of FIG. 3 and, FIG. 4. In FIG. 3, the left end curve and right end curve are the lateral hyperbolic surfaces 110 of the light-entering part 100, and the top end is the top convex surface 130. In FIG. 4, the left and right end curves are the lateral synclastic surfaces 120 of the light-entering part 100. In this embodiment, the lateral hyperbolic surfaces 110 of the light-entering part 100 face the tapered surfaces 210 of the reflection part 200, and the lateral synclastic surfaces 120 to the inclined planes 220.

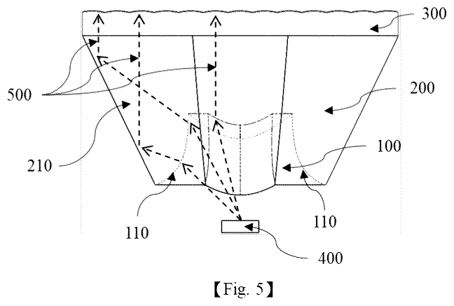

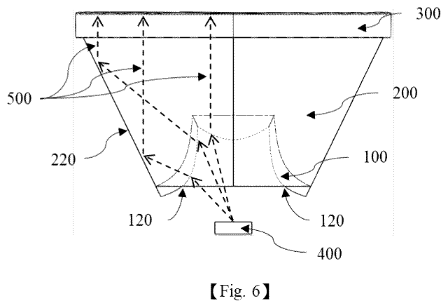

FIG. 5 and FIG. 6 show the light path 500 of embodiments shown as FIG. 3 and FIG. 4. First, the light from the light source 400 is injected into groove, i.e. the light-entering part 100, and is refracted by the lateral curve surfaces and the top convex surface of the light-entering part 100. The zone angle of the direct light is determined by the curvature of the top surface 130, and the injection angles of light to the reflection part 200 are determined by the curvature of the lateral surfaces. The light is reflected by the reflection part 200, and then the light reaches and passes through the light-exiting surface 300.

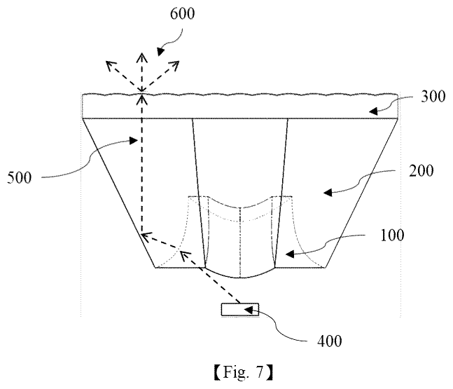

FIG. 7 shows the illumination effect of the embodiments shown as FIG. 5 and FIG. 6. The light 500 is scattered by the pattern of the light-exiting surface 300 when passing through, shown as the scattering light 600 in FIG. 7. It is easy to understand that a different pattern of the light-exiting part 300 has a different scattering effect and that incurs different illumination effect or illumination profile.

FIG. 8 and FIG. 9 show an embodiment with a designed light-exiting part 300 according to one embodiment of the present invention. In this embodiment, the surface of the light-exiting part 300 has an inhomogeneous thickness distribution. This variation in thickness is designed to bend the light beam 500 and create a specific light pattern. FIG. 8 shows the embodiment in the left/right view and FIG. 9 the front/rear view.

Referring to FIG. 8, the right of the light-exiting part 300 is getting thinner and has a one-dimensional wave, which means the arrangement is not symmetrical in the right-left direction but symmetrical in the front-rear direction.

Referring to FIG. 9, the light path 500 shows the light is from light source 400, passes the light-entering part 100 and enters into the light guide, is refracted by the curve surfaces of the light-entering part 100, then is reflected by the reflection part 200, and then scattered by the pattern on the light-exiting part 300 to form the scattering light 600. In this embodiment, the light is inclined when is reflected by the reflection part 200. When passing the light-exiting part 300, the light is bent more by the thinner pattern of the right semi-surface, shown in FIG. 9, and there is no such illumination effect to the left semi-surface of the light-exiting part 300. It is easy to understood that the inhomogeneous thickness of the light-exiting part has a specialized illumination effect.

### Extension

The lateral curve surfaces of the groove, the light-entering part, can be the surfaces with different curvatures. For example, each of these multiple pairs of opposite curve surfaces comprises two surfaces with the same curvature and are arranged in opposite relative to the collimated axis. Similarly, the reflection surfaces of the reflection part can be the interlaced tapered surfaces and the inclined surfaces with different inclined angles. Two opposite tapered surfaces and two inclined surfaces relative to the collimated axis form a pair of reflection surfaces. Each pair of tapered surfaces and the incline surfaces are arranged to face one pair of lateral curve surfaces of the light-entering part.

The reflection rate can be designed, which depends on the curvature of the lateral curve surface of the light-entering part, refractive index of the light guide, the inclined angle of the reflection part and so on. If necessary, there are many ways to have the total reflection effect on the surface of the reflection part, such as to have a specialized curvature of the lateral curve surface of the light-entering part, to have a specialized inclined angle of the reflection part, to use the light guide with a specialized refractive index or to coat a mirror layer (reflection material) on surfaces of the reflection part. For example, the curvatures of the curve surfaces of the light-entering part are designed. When the light reaches the reflection part, the light is refracted by the curve surfaces and the reflected angle by the reflection part is larger than the critical angle of the reflector to obtain the effect of total reflection. Also, it is empathically noted that the inventor found the inclined plane and the tapered surfaces have better performance, but it can be parabolic surface or other geometrical shape.

The lateral curve surfaces of the light-entering part can have a variant arrangement or different curvature to obtain a different illumination effect. The curvature of any lateral curve surface and arrangement should not be limited by embodiments herein. Also, the arrangement of the tapered surfaces and the inclined surfaces should not be limited by the embodiments herein.

### Conclusion

The invention proposes to use a light guide to make a reflector of a lamp. A groove of multiple curve surfaces at the light guide bottom is design to accept a light, reflected by the lateral surface, and passing through the light-exiting part to fly out the light guide. A good light guide as the reflector can enhance the illumination performance and increase the design flexibility of the illumination profile. The one-piece component is easy to manufacture and miniaturization in comparison with the conventional reflector.

1. A light-guide reflector made by a light guide, comprising
a light-entering part, a groove at a thin end of the reflector, wherein the groove has multiple lateral curve surfaces and a top convex surface,
a reflection part, the lateral side of the reflector and around the light-receiving part, with multiple reflection surfaces wherein the reflection surfaces are faced to the lateral curve surfaces of the light-entering part, and
a light-exiting part at a larger end of the reflector, wherein the light-entering, the reflection part and the light-exiting part are arranged along a collimated axis.

2. The light-guide reflector of claim 1, wherein any curvature of the lateral curve surface of the light-entering part is different from each other.

3. The light-guide reflector of claim 1, wherein part of curvatures of the lateral curve surfaces of the light-entering part are the same.

4. The light-guide reflector of claim 1, wherein any of the lateral curve surfaces of the light-entering part is a hyperbolic surface or a synclastic surface.

5. The light-guide reflector of claim 1, wherein the lateral curve surfaces of the light-entering part comprise multiple pairs of opposite curve surfaces with the same curvature, and each pair of opposite curve surfaces are arranged in symmetrical relative to the collimated axis.

6. The light-guide reflector of claim 1, wherein the lateral curve surfaces of the light-entering part comprise multiple interlaced pairs of hyperbolic surfaces and pairs of synclastic surfaces, each pair of the hyperbolic surfaces and each pair of the synclastic surface are arranged in symmetrical relative to the collimated axis.

7. The light-guide reflector of claim 1, wherein the reflection surfaces of the reflection part comprise multiple interlaced tapered and inclined surfaces, and the inclined angle of the tapered and inclined surfaces are different in total or in part relative to the collimated axis.

8. The light-guide reflector of claim 1, wherein the reflection surfaces of the reflection part comprise multiple pairs of opposite interlaced tapered and inclined surfaces, and the tapered and inclined surfaces are arranged in symmetrical relative to the collimated axis.

9. The light-guide reflector of claim 1, wherein the lateral curve surfaces of the light-entering part comprise a pair of opposite lateral hyperbolic surfaces and a pair of opposite lateral synclastic surfaces.

10. The light-guide reflector of claim 9, wherein the reflection surfaces of the reflection part comprise a pair of opposite tapered surfaces and a pair of opposite inclined surfaces.

11. The light-guide reflector of claim 10, wherein any of tapered surface of the reflection part is faced to one of the lateral hyperbolic surfaces of the light-entering part, any of the inclined surface of the reflection part to one of the synclastic surface of the light-entering surface.

12. The light-guide reflector of claim 1, wherein surfaces of the reflection part are coated by a reflection material to obtain an effect of total reflection.

13. The light-guide reflector of claim 1, wherein an inclined angle of the reflection part is larger than a critical angle of total reflection of the light from the lateral curve surface of the light-entering part to have an effect of total reflection.

14. The light-guide reflector of claim 13, wherein curvatures of the lateral curve surfaces of the light-entering part are designed to obtain the effect of total reflection.

15. The light-guide reflector of claim 13, wherein the light guide of the light-guide reflector has a designed refractive index to obtain the effect of total reflection.

16. The light-guide reflector of claim 1, wherein the light-exiting part comprises a pattern for expressing an illumination profile.

17. The light-guide reflector of claim 16, wherein the pattern of the light-exiting part is a one-dimensional wave, a two-dimensional wave, a concentric-circle wave, a fish scale.
